(19) United States
(12) Patent Application Publication
(10) Pub. No.: US 2008/0285503 A1
(43) Pub. Date: Nov. 20, 2008

(54) Device and Method for Transmission and Reception of Group Messages Via a Satellite Link

(75) Inventor: Mikael Lagerman, Goteborg (SE)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 12/091,824

(22) PCT Filed: Nov. 11, 2005
(86) PCT No.: PCT/SE2005/001696

§ 371 Date: Apr. 28, 2008

(51) Int. Cl. H04B 7/185

(52) U.S. Cl. 370/316

(57) ABSTRACT

The present invention relates to a device (4, 5, 6, 7, 8) adapted for transmission and reception via a satellite link (2) in a satellite communication system (3). The device (4, 5, 6, 7, 8) is further a part of a group (9, 21) of similar devices (4, 5, 6, 7, 8), where the device (4, 5, 6, 7, 8) comprises a first address (14), unique for the device (4, 5, 6, 7, 8). The device (4, 5, 6, 7, 8) further comprises at least a second address (15, 19) that is common for the group (9, 21), enabling a message (22a, 22b, 22c) sent to the group (9, 21) to be addressed to the group (9, 21). This means that a single transmission is sufficient to reach all members (4, 5, 6, 7, 8) in the group (9, 21). The present invention also relates to a satellite communications system comprising devices according to the above. The present invention also relates to a method for transmission and reception via a satellite link.

### TECHNICAL FIELD

The present invention relates to a device adapted for transmission and reception via a satellite link in a satellite communication system, which device further is a part of a group of similar devices, where the device comprises a first address, unique for the device.

The present invention also relates to a satellite communications system comprising devices according to the above.

The present invention also relates to a method for transmission and reception via a satellite link, being part of a satellite communication system.

### BACKGROUND ART

Communication by means of a satellite link is sometimes desirable or necessary. In, for example, desert areas, at sea or in other areas which are poorly covered or not covered at all by a general cell phone system or a fixed telephone net (i.e. where a communication infrastructure is absent), such satellite communication is required.

A satellite transmission is received by many devices adapted for transmission and reception, in the following called T/R devices, since a satellite antenna transmits broadly. One satellite may cover half the world with one antenna lobe, and all T/R devices adapted to the right frequency will receive the transmission. In a particular T/R device itself, it is determined whether a received message was intended for said T/R device or not. If the message was not intended for the T/R device in question, the message is deleted by the T/R device. The T/R device may for example be a telephone or a portable computer, having a satellite interface arranged for satellite communication.

In order to perform this function, each one of the T/R devices usually comprises a modem, which in turn comprises a unique device address. The unique device address is by way of example realized in the form of a so-called SIM-card.

A group broadcast is a satellite transmission directed towards a group of T/R devices, each T/R device having a respective user, for example a group of reporters in Africa which are contacted by their newspaper. Today, a group broadcast is achieved by transmitting the same message multiple times, once per participant in the group, where each message is equipped with a certain T/R device's unique address until all T/R devices have been addressed. If a first message is equipped with the user address of a first T/R device in the group, this means that all the T/R devices in the group receives the message, but all the T/R devices except the first T/R device deletes the first message. A second message, equipped with the user address of a second T/R device in the group, but equal to the first message in all other aspects, is then transmitted. Now all the T/R devices except the second T/R device deletes the second message, and this procedure is repeated until all the T/R devices in the group have received the message in question.

This is a problem, since this multiple transmission of the same message (sequential re-transmission) is inefficient for the satellite system, and expensive for the users. A user normally pays for the amount of date that is transmitted as a total.

### DISCLOSURE OF THE INVENTION

The objective problem that is solved by the present invention is to transmit a message via a satellite link to a predefined group only once, and then reach all the T/R devices in the group with this single transmission. Furthermore, T/R devices which are not members of the predefined group should delete the message.

The objective problem is solved by means of a device as described in the introduction. The device is further characterized in that the device comprises at least a second address that is common for the group, enabling a message sent to the group to be addressed to the group, resulting in a single transmission to reach all members in the group.

The objective problem is also solved by means of a method as described in the introduction. The method is further characterized in that that it comprises the steps: addressing a message with a group address; transmitting the message via the satellite link; and using the group address to reach a predetermined group of receivers with only one transmission.

Preferred embodiments are evident from the dependent claims.

A number of advantages are provided by means of the present invention. For example:
the more efficient group broadcast strategy according to the present invention reduces link load and link cost and contributes less to the overall satellite link congestion
the delay between the data arrival to the different receivers due to sequential re-transmissions is essentially eliminated.

### BRIEF DESCRIPTION OF THE DRAWINGS

The present invention will now be described more in detail with reference to the appended drawings. where:

FIG. 1 discloses a number of T/R devices in a satellite communication system;

FIG. 2 discloses a first T/R device structure;

FIG. 3 discloses a second T/R device structure;

FIG. 4a discloses a first message structure;

FIG. 4b discloses a second message structure; and

FIG. 4c discloses a third message structure.

### PREFERRED EMBODIMENTS

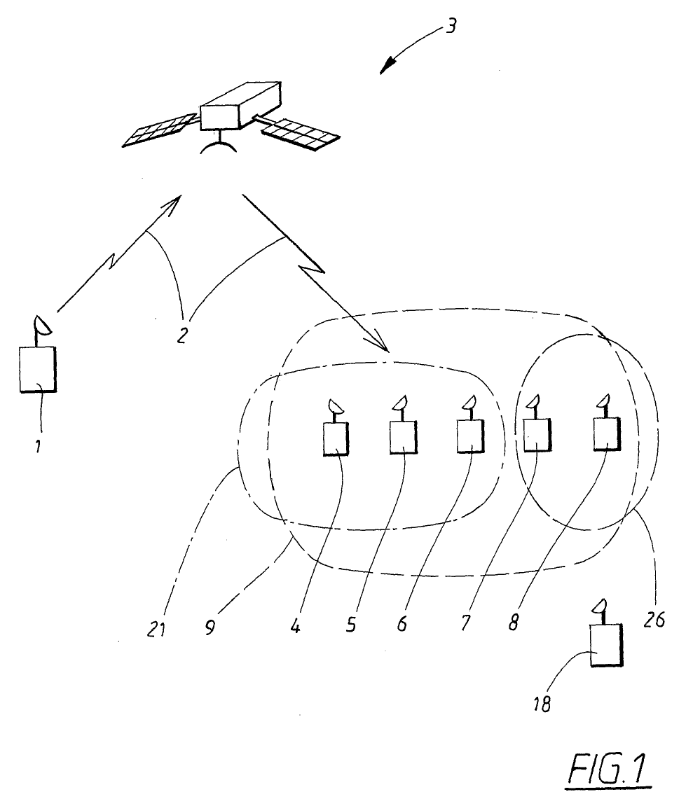

According to a first embodiment, as showed in FIG. 1, a first device 1 adapted for transmission and reception, in the following called a T/R device, is arranged to communicate via a satellite link 2 being part of a satellite communication system 3. Said T/R device 1, and the other T/R devices which are mentioned below, may for example be telephones or portable computers, arranged to communicate via a satellite link. Second 4, third 5, fourth 6, fifth 7 and sixth 8 T/R devices are scattered, and are also arranged to communicate via the satellite link 2. The second, 4, third 5, fourth 6, fifth 7 and sixth 8 T/R devices are in this example members of a first broadcast group 9, where the first T/R device 4 is going to transmit a first message to the first broadcast group 9. Each one of the T/R devices 1, 4, 5, 6, 7, 8 is normally associated with one or more users (not shown).

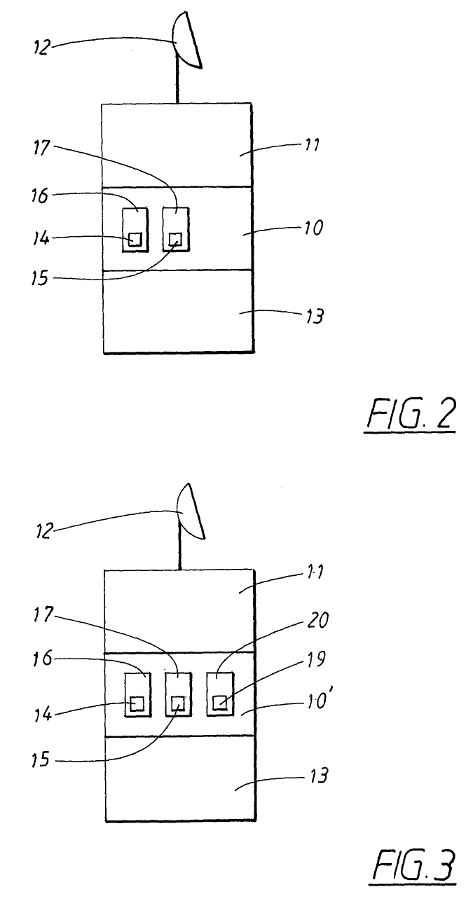

With reference also to FIG. 2, each one of the T/R devices 1, 4, 5, 6, 7, 8 comprises a modem 10, transmit and receive circuitry 11 and an antenna 12. Each one of the T/R devices 1, 4, 5, 6, 7, 8 also comprises equipment 13 for handling information and performing actions depending on the current circumstances, for example a microcomputer. Those actions comprise determining if a message is sent to an address which is comprised in the current T/R device. If the address is comprised in the current T/R device, the user of current T/R device is permitted to access the. message. Otherwise the message is deleted.

According to the present invention, each modem 10 is equipped with at least two addresses or user ID:s, where a first address is personal and each one of the other address or addresses is common for all T/R devices in a certain broadcast group. The present invention thus enables at least two addresses to be used.

According to a first embodiment of the present invention, the modem 10 comprises two addresses 14, 15, a first address 14 which is personal and a second address 15 which is common for the first broadcast group 9. The first, personal, address 14 is unique, while the second, broadcast, address 15 is the same for all the T/R devices 4, 5, 6, 7, 8 in the first broadcast group 9. Each address 14, 15 is inserted into the modem 10 in the form of respective so-called SIM (subscriber identity module) cards 16, 17. In FIG. 1, one T/R device 18 not belonging to the first broadcast group 9 is shown.

Firstly, the first T/R device 1 sends a first message, and addresses all the T/R devices 4, 5, 6, 7, 8 in the first broadcast group 9. By means of the second address 15, these T/R devices 4, 5, 6, 7, 8 in the first broadcast group 9 will identify themselves as the correct receiver of the first message, and permit the user of the respective T/R device 4, 5, 6, 7, 8 in the first broadcast group 9 to access the first message. All other T/R devices 18 which are not members of the first broadcast group, but have received said message anyway, will not identify themselves as the correct receiver of the first message and delete it.

In this way, only one transmission is necessary in order to reach all the users in the first broadcast group 9. The first T/R device 1 then transmits a second message and addresses it to the second T/R device 4 only, using the first, personal, address 14. No other T/R device than the second T/R device 4 will identify itself as the correct receiver, leading to that all the T/R devices 4, 5, 6, 7, 8, 18 which have received the second message, except the second T/R device 4, will delete the second message.

In a second embodiment, with reference to FIGS. 1 and 3, the modem 10′ comprises three addresses 14, 15, 19, one in each one of three corresponding SIM cards 16, 17, 20. The first address 14 is personal and the second address 15 is common for the first broadcast group and the third address 20 is common for a second broadcast group 21. In this example the second broadcast group comprises the second 4, third 5 and fourth 6 T/R device.

The first T/R device 1 now transmits a third message and addresses it to the second broadcast group 21 only, using the third address 19. All the T/R devices 4, 5, 6 in the second broadcast group 21 will identify themselves as the correct receiver of the third message, and permit the user of the respective T/R device 4, 5, 6 in the second broadcast group 21 to access the third message. All other T/R devices 7, 8, 18, which are not members of the second broadcast group 21 but have received said message anyway, will not identify themselves as the correct receiver of the third message and delete it.

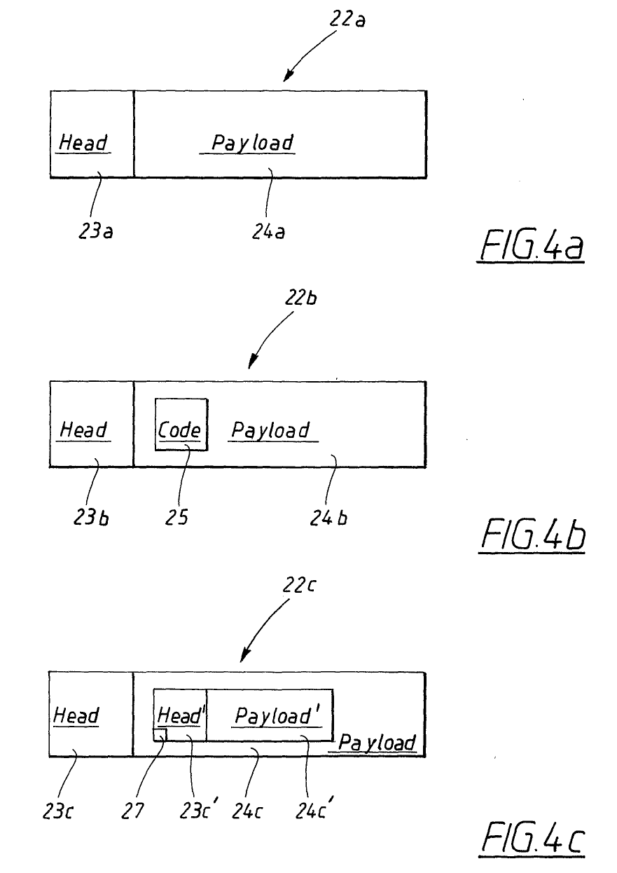

When describing the following embodiments of the present invention, it is necessary to first describe how a message is structured. As shown in FIG. 4a, a first message type 22a comprises a head 23a and a payload 24a. The head 23a in turn comprises the address that the message is directed to. The payload 24a is generally the actual contents of the message.

A second message type 22b is shown in FIG. 4b, having a head 23b of the same type as the one discussed with reference to FIG. 4a. A payload 24b comprises a code 25 and the actual contents of the message.

As shown in FIG. 4c, a third message type comprises a first head 23c being of the same type as the one discussed with reference to FIGS. 4a and 4b, and a first payload 24c. The first payload 24c in turn comprises a second head 23c′ and a second payload 24c′. The second head 23c′ comprises a subgroup address 27, and the second payload 24c′ comprises the actual contents of the message.

The message structure according to FIG. 4a corresponds to the embodiments described above.

A third embodiment will now be described with reference now to FIGS. 1, 2 and 4b. The first T/R device 1 sends a fourth message, where the payload 24b comprises a code 25, and addresses all the T/R devices 4, 5, 6, 7, 8 in the first broadcast group 9. As described previously, all the T/R devices 4, 5, 6, 7, 8 in the first broadcast group 9 will identify themselves as the correct receiver of the fourth message, and permit the user of the respective T/R device 4, 5, 6, 7, 8 in the first broadcast group 9 to access the first message.

However, without proper encryption means for unlocking the code 25, the actual contents of the message will not be meaningful. Only those T/R devices in the first broadcast group 9 which are equipped with a proper encryption means will be able to take part of the actual contents of the fourth message.

Such encryption means is often in the form of a key. The keys may have to be changed in such a way that a new code is used and a new key is distributed to those concerned at certain times, for example once a day or once a month. The key may also be of a fixed type, not being changeable, installed at the device set-up.

In a relatively fast and simple variety of the third embodiment, the code is in the form of an address string. The address string comprises a predetermined number of bits, where each bit corresponds to a certain T/R device. If the value of a certain bit is “0”, the corresponding T/R device will delete the message. If the value of this certain bit is “1”, the corresponding T/R device will permit the user of the T/R device access the message. This variety has disadvantages, though. If the number of T/R devices is high, the length of the address string will not be sufficient or intrude on the size of the actual message to an unacceptable degree. The fourth embodiment below provides an alternative solution.

The fourth embodiment will now be described with reference to FIGS. 1, 3 and 4c. The first T/R device sends a fifth message, where the second head 23c′ comprises a subgroup address 25 in the form of a subgroup address string. The subgroup address 25 addresses a certain subgroup 26 of the first broadcast group 9, in a similar way as in the second embodiment. In the example, the subgroup comprises the fourth 7 and fifth 8 T/R device. The subgroup address string comprises a predetermined number of bits, where the bit string provides a number. This number identifies which subgroup that is addressed. The relevant subgroup identity may be implemented in each T/R device at an initial stage, but may also be implemented via a message sent to the T/R devices, updating the current subgroup arrangement. Of course, the relevant subgroup identity may be implemented in each T/R device before the subgroup in question is called.

The T/R devices 4, 5, 6, 7, 8 in the first broadcast group 9 will identify themselves as the correct receiver of the fifth message's first head 23c, but then, in a secondary process, only the subgroup 26 of the first broadcast group 9 will identify themselves as the correct receiver of the fifth message and permit the users of these T/R devices 7, 8 to access the fifth message. All receiving T/R devices 4, 5, 6, 18 but the fourth 7 and fifth 8 will not identify themselves as the correct receiver of the fifth message and delete it.

Regarding all embodiments described, acknowledge handling may be desired. Some protocols, e.g. TCP (Transmission Control Protocol), include an acknowledge mechanism and re-transmission process. Confusion would result if multiple acknowledgements arrived to the originator, in the example the first T/R device, in response of one message.

Examples of four preferred strategies follow below:

1. Each receiving T/R device 4, 5, 6, 7, 8 acknowledges its reception each time the reception is performed properly. This can be used by the transmitting terminal, in the examples the first T/R device 1, to track all messages and to issue one acknowledge message to the originating application after all outstanding acknowledges have been accounted for. Such an originating application may be a basic piece of software, such as a file reader, which is not capable of handling more than one acknowledge message at a time.
2. A cyclic acknowledge mechanism is applied at the receiving T/R devices 4, 5, 6, 7, 8. All but one receiving T/R device suppress the acknowledge. The receiving T/R devices 4, 5, 6, 7, 8 take turns in a round robin fashion to send the single acknowledge message. That means that in our example with five receiving T/R devices 4, 5, 6, 7, 8, each T/R device will issue an acknowledge message every fifth time. An acknowledge message for a certain T/R device comprises the results of the last five transmission for that T/R device. In the event of one or more failed transmissions, re-transmission of these is performed for that specific T/R device. In order to cover all transmissions, by way of example, all T/R devices issue one more acknowledge message when the transmission in question is complete. Generally, the acknowledge message for a certain T/R device comprises the results of those transmissions which have been performed for that T/R device since its last acknowledge message.
3. Negative acknowledge. Only those receiving T/R devices that fail to restore the transmitted message send a negative acknowledge. Preferably, the transmitting terminal, in the examples the first T/R device 1, has to provide positive acknowledge messages to the originating application when no negative acknowledge messages are received.
4. The simplest solution: No protocols requiring acknowledge are supported in a small group peer-to-multicast mode. In other words, only those originating software applications which do not require acknowledgements are allowed, for example UDP (User Datagram Protocol).

Common for the three first strategies is that acknowledge handling has to be performed at both ends of the satellite link to provide a familiar interface to the originating applications (or end applications). Furthermore, the acknowledge message for the three first strategies preferably comprises the acknowledging device's unique device address 14.

The present invention is not limited to the above described embodiments, but may vary freely within the scope of the appended claims. For example, any possible combination of the embodiments described above is conceivable. The coded message, needing a decryption key, may for example be utilized in any one of the embodiments above. In this way, a higher level of security is obtained, since even if a T/R device, which is not a member of a receiving group, is tampered with in such a way that it does not delete the incoming message, the user will not be able to access the actual message without the decryption key.

Furthermore, the number of members in each broadcast group 9, 21, 28, and how each broadcast group 9, 21, 28 is constituted, may vary in any conceivable way. In the second embodiment example, it is possible that the second broadcast group only comprises one or more T/R devices which are not part of the first broadcast group 9, for example the T/R device with the reference sign 18. The first and second broadcast groups may also be more or less overlapping, where at least one of the T/R devices in the first broadcast group also is a part of the second broadcast group, but where at least one T/R device in the second broadcast group is not part of the first broadcast group (not shown).

With reference to the second embodiment, a modem 10, 10′ may comprise more than the three addresses disclosed in that embodiment example.

Furthermore, the addresses 14, 15, 19 may be inserted into the modem 10, 10′ in many other ways. For example, the addresses 14, 15, 19 may be programmed into a re-programmable memory which may be re-programmed in a suitable manner. The addresses 14, 15, 19 may also be in the form of an embedded, not exchangeable, hardware address. When the addresses 14, 15, 19 are in the form of exchangeable cards, not only SIM cards 16, 17, 20 may be used, but any other suitable card or insertable module may be used. One card or module may comprise more than one address. Of course, any combination of the above is conceivable as well.

It is not necessary that the T/R devices are constituted in the way as described preciously. For example, the addresses may be implemented in some other part than the modem, the T/R device might not even comprise a modem.

The addresses may be in any suitable form, for example in the form of an IP (Internet Protocol) address.

With reference to FIG. 2 and FIG. 3, the equipment 13 for handling information and performing actions depending on the current circumstances, for example a microcomputer, may be more or less integrated with the modem 10.

1. A device adapted for transmission and reception via a satellite link in a satellite communication system, wherein said device is a part of a group of similar devices, said device comprising:
a first address, unique for the device;
at least a second address that is common for the group, thereby enabling a message sent to the group to be addressed to the group, resulting in a single transmission to reach all members in the group.

2. The device according to claim 1, wherein the device comprises more than two addresses, wherein each address, except the first unique address, is common for a certain respective group.

3. The device according to claim 1, wherein the message comprises a head and a payload, where the head comprises the group address for the group to which the message is directed.

4. The device according to claim 3, wherein the payload comprises an address string, which address string comprises information regarding which of the individual devices in the group that the message is directed to.

5. The device according to claim 3, wherein the payload comprises an address string, which address string comprises information regarding which subgroup, at least partly within the group of the group address, that the message is directed to.

6. The device according to claim 3, wherein the payload is encrypted, and where only those devices to which the message is directed are provided with a proper decryption key.

7. The device according to claim 1, wherein the devices to which the message is directed and which have received the message properly are arranged to send an acknowledge message.

8. The device according to claim 1, wherein the devices to which the message is directed are arranged to take turns in sending an acknowledge message, where the acknowledge message for a certain device comprises the results of those transmission which have been performed for that device since its last acknowledge message.

9. The device according to claim 1, wherein the devices to which the message is directed and which have not received the message properly are arranged to send a negative acknowledge message.

10. The device according claim 7, wherein each acknowledge message comprises the acknowledging device's unique first address.

11. The device according to claim 1, wherein only originating software applications which do not require acknowledge messages are allowed.

12. (canceled)

13. A method for transmission and reception via a satellite link, being part of a satellite communication system, characterized in that the method comprises the steps of:
addressing a message with a group address;
transmitting the message via the satellite link; and,
using the group address to reach a predetermined group of receivers with only one transmission.

14. The method according to claim 13, wherein the method further comprises the steps:
incorporating at least one subgroup address in the message.

15. The method according to claim 13, wherein the method further comprises the steps:
encrypting a payload of the message before transmitting it; and,
decrypting the payload at a receiver by means of a decryption key.

16. The method according to claim 13, wherein the receivers to which the message is directed and which have received the message properly, send an acknowledge message.

17. The method according to claim 13, wherein the receivers to which the message is directed take turns in sending an acknowledge message, where the acknowledge message for a certain device comprises the results of those transmission which have been performed for that device since its last acknowledge message.

18. The method according to claim 13, wherein the receivers to which the message is directed and which have not received the message properly send a negative acknowledge message.

19. The method according to claim 16, wherein each acknowledge message comprises the acknowledging receiver's unique first address.

20. The method according to claim 13, wherein only originating software applications which do not require acknowledge messages are allowed.
